(19) United States
(12) Patent Application Publication
(10) Pub. No.: US 2021/0258205 A1
(43) Pub. Date: Aug. 19, 2021

(54) NETWORK MONITORING DEVICE AND NETWORK MONITORING METHOD

(71) Applicant: NEC Corporation, Tokyo (JP)

(72) Inventor: Shigeyuki YANAGIMACHI, Tokyo (JP)

(73) Assignee: NEC Corporation, Tokyo (JP)

(21) Appl. No.: 17/173,656

(22) Filed: Feb. 11, 2021

(30) Foreign Application Priority Data
Feb. 19, 2020 (JP) 2020-026129

(51) Int. Cl. H04L 12/24; H04W 24/08; H04W 76/19; H04B 17/336; H04B 7/06

(52) U.S. Cl. CPC H04L 41/0686; H04W 24/08; H04B 7/0626; H04B 17/336; H04W 76/19

(57) ABSTRACT

In order to quickly estimate an abnormal transponder at low cost, a network monitoring device acquires, when sensing a failure occurrence channel, route information of the failure occurrence channel. The network monitoring device generates an adjacent channel table in which an adjacent channel being close in wavelength to the failure occurrence channel is extracted, then generates an interference channel table in which an interference channel sharing a common route with the failure occurrence channel among the adjacent channels is extracted, and then performs weighting on the interference channel, based on closeness of wavelength to the failure occurrence channel, and generates an influence channel table in which a weight is given to the interference channel. The network monitoring device estimates, based on the influence channel table, a channel with a large weight to be a channel having a possibility of exerting a negative influence on the failure occurrence channel.

This application is based upon and claims the benefit of priority from Japanese Patent Application No. 2020-026129, filed on Feb. 19, 2020, the disclosure of which is incorporated herein in its entirety by reference.

### TECHNICAL FIELD

The present invention relates to a network monitoring device and a network monitoring method.

### BACKGROUND ART

In recent years, a movement toward disaggregation of an optical communication system to be used in a communication network, a data center, or the like has been active mainly in a major communication carrier or a major service provider. The disaggregation is a method of dividing a general all-in-one type communication system into functional blocks (e.g., a transponder, a switch, an optical amplifier, and the like), and constituting a communication system by only a necessary function and a necessary quantity.

While an all-in-one type is supplied by one communication system vendor, a disaggregation type communication system enables freely combining pieces of equipment of a plurality of vendors by a necessary quantity, and thus a cost reduction effect of the communication system is anticipated. Movements toward normalization and multi source agreement (MSA) are also active mainly in North America. Standardization, coordinated operation verification, and the like advance in Open Network Foundation (ONF), ITU-T, and the like for normalization, and in Open ROADM, Telecom Infra Project (TIP) and the like for MSA. ITU-T is an abbreviation for the International Telecommunication Union Telecommunication Standardization Sector.

The all-in-one type communication system is supplied by one communication system vendor. Thus, the all-in-one type communication system is designed in such a way that communication quality is ensured in a communication network constituted of a plurality of nodes as well.

In contrast, the disaggregation type communication system is constituted of pieces of multivendor equipment, and therefore, a structure that ensures communication quality is separately needed. Normally, even in a multivendor equipment mixed environment, opposite transponders (hereinafter, also described as TPNDs) use the same vendor in order to ensure communication quality. However, in a wavelength division multiplexing (WDM) scheme, a plurality of optical signals differing in wavelength channel are simultaneously transmitted. Thus, a maker of a TPND to be used may differ for each channel. In this case, a plurality of optical signals transmitted by TPNDs differing in specification are mixed in the same route. In such a case, there is a possibility that a channel of a certain wavelength receives an unexpected influence from an adjacent channel having a close wavelength. Actually, according to an evaluation of a plurality of TPNDs, optical power and optical spectrum width differ depending on a vendor.

From a background as above, monitoring communication quality in each place of a route is important in the disaggregation type communication system. In order to perform highly reliable monitoring, for example, disposing a spectrum analyzer in a node or a link of a route, and monitoring optical power, optical spectrum width, and the like can be conceived. However, a spectrum analyzer is expensive, and there is a problem that cost increases when a monitoring system in which a large number of spectrum analyzers are disposed is built.

Thus, there is suggested a method of performing highly reliable monitoring while holding down an increase of cost. For example, PTL 1 (Japanese Unexamined Patent Application Publication (Translation of PCT Application) No. 2014-523149) discloses a method of detecting deterioration of an optical channel by utilizing a forward error correction (FEC) unit or a digital signal processing (DSP) unit provided in a transponder, and reducing cost of a monitoring device. Herein, FEC is an abbreviation for forward error correction, and DSP is an abbreviation for digital signal processor.

In the method of PTL 1, for example, for a non-digital coherent communication scheme, a transponder acquires a bit error rate (BER) as a quality parameter, and transmits the bit error rate to a network management device. For example, for a digital coherent communication scheme, a DSP acquires, as a quality parameter, wavelength dispersion (CD), polarization mode dispersion (PMD), optical signal noise ratio (OSNR), or the like, and transmits the quality parameter to a network management device. CD is an abbreviation for chromatic dispersion, PMD is an abbreviation for polarization mode dispersion, and OSNR is an abbreviation for optical signal noise ratio.

In a network management device, a path having deteriorated communication quality is detected as a first deteriorated path, based on a received quality parameter. An associated path having an association with the first deteriorated path is specified. Further, among associated paths, a path having deteriorated communication quality is detected as a second deteriorated path. Thereafter, a node and a link where both the first deteriorated path and the second deteriorated path pass are specified to be a fault node and a fault link. In this way, highly reliable monitoring can be performed while holding down cost.

PTL 2 (Japanese Unexamined Patent Application Publication No. 2010-135937) discloses a technique of superimposing a tone modulation signal differing for each transponder on a main signal of each channel in a communication of a WDM scheme. In this method, since a transponder can be identified by a tone signal, a transponder in which a trouble occurs can be specified by monitoring the tone signal.

### SUMMARY

However, the scheme of PTL 1 is able to sense breaking of an optical transmission line or a fault in an optical node unit, but is unable to correctly determine which transponder exerts a negative influence on a channel in which a failure occurs.

The scheme of PTL 2 is limited in the number of tone modulation signals to be superimposed, and therefore, has a scalability problem of being unable to increase channels to be applied to a certain number or more.

The present invention is made in view of the problems described above, and is intended to provide an optical network monitoring device that can quickly estimate an abnormal transponder at low cost.

In order to solve the problem described above, a network monitoring device acquires, when sensing a failure occurrence channel, route information of the channel in which a failure occurs. The network monitoring device generates an adjacent channel table in which an adjacent channel being close in wavelength to the failure occurrence channel is extracted. Next, the network monitoring device generates an interference channel table in which an interference channel sharing a common route with the failure occurrence channel among the adjacent channels is extracted. Next, the network monitoring device performs weighting on the interference channel, based on closeness of wavelength to the failure occurrence channel, and generates an influence channel table in which a weight is given to the interference channel. The network monitoring device then estimates, based on the influence channel table, a channel with a large weight to be a channel having a possibility of exerting a negative influence on the failure occurrence channel.

As described above, the present invention is able to provide an optical network monitoring device that can quickly estimate an abnormal transponder at low cost.

### BRIEF DESCRIPTION OF THE DRAWINGS

Exemplary features and advantages of the present invention will become apparent from the following detailed description when taken with the accompanying drawings in which:

FIG. 1 is a block diagram illustrating a network monitoring device according to a first example embodiment;

FIG. 2 is a conceptual diagram illustrating one example of a configuration of an all-in-one type communication system;

FIG. 3 is a conceptual diagram illustrating one example of a configuration of a disaggregation type communication system;

FIG. 4 is a schematic diagram of a transmission status in a multivendor equipment mixed environment;

FIG. 5 is a schematic diagram illustrating one example of a disaggregation type communication network using a network monitoring device according to a second example embodiment;

FIG. 6 is a block diagram illustrating a configuration of the network monitoring device according to the second example embodiment;

FIG. 7 is a schematic diagram illustrating a specific example of the disaggregation type communication network using the network monitoring device according to the second example embodiment;

FIG. 8 is a table illustrating one example of a channel route table;

FIG. 9 is a table illustrating one example of an adjacent channel table;

FIG. 10 is a table illustrating one example of an interference channel table;

FIG. 11 is a table illustrating one example of an influence channel table;

FIG. 12 is a flowchart illustrating an operation of the network monitoring device according to the second example embodiment;

FIG. 13 is a schematic diagram illustrating one example of a disaggregation type communication network using a network monitoring device according to a third example embodiment;

FIG. 14 is a flowchart illustrating an operation of the network monitoring device according to the third example embodiment;

FIG. 15 is a schematic diagram illustrating one example of a disaggregation type communication network using a network monitoring device according to a fourth example embodiment;

FIG. 16 is a flowchart illustrating an operation of the network monitoring device according to the fourth example embodiment; and

FIG. 17 is a schematic diagram illustrating a network monitoring system according to a fifth example embodiment.

### EXAMPLE EMBODIMENT

Example embodiments of the present invention will be described below in detail with reference to the drawings. However, technically preferable limitation is imposed on the example embodiments described below in order to practice the present invention, but does not limit the scope of the invention to the following. The same reference sign may be assigned to a similar component in each of the drawings, and description thereof may be omitted.

### First Example Embodiment

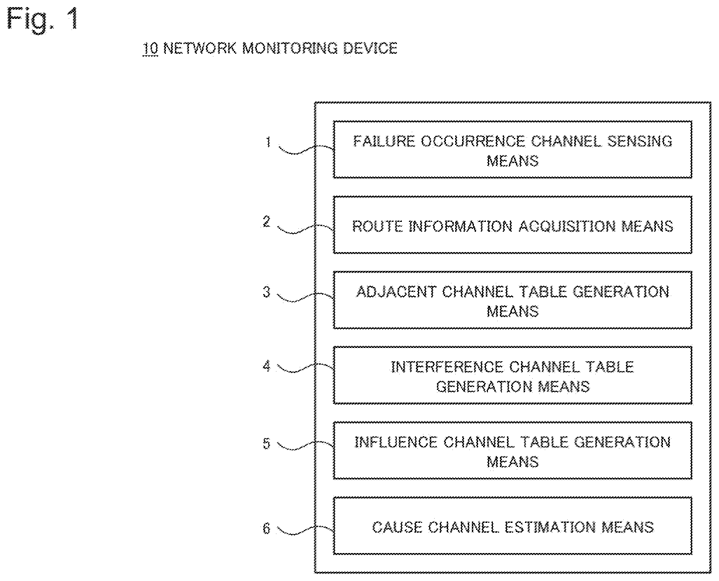

FIG. 1 is a block diagram illustrating a network monitoring device 10 according to the present example embodiment. The network monitoring device 10 includes a failure occurrence channel sensing means 1, a route information acquisition means 2, an adjacent channel table generation means 3, an interference channel table generation means 4, an influence channel table generation means 5, and a cause channel estimation means 6.

The network monitoring device 10 monitors a state of an optical communication network constituted of a node, and a link connecting nodes. Herein, a state of a network includes, for example, a communication quality of each channel in the network, a state of a node, a state of a link, and the like.

The failure occurrence channel sensing means 1 senses a channel in which a failure occurs in a network.

The route information acquisition means 2 acquires route information of a channel in which a failure occurs. At this point, the route information acquisition means 2 also acquires route information of another channel being close in wavelength to the failure occurrence channel.

The adjacent channel table generation means 3 extracts an adjacent channel being close in wavelength to the failure occurrence channel, and generates an adjacent channel table including route information of the adjacent channel.

The interference channel table generation means 4 extracts, as an interference channel, a channel sharing a common route with the failure occurrence channel among the adjacent channels, and generates an interference channel table.

The influence channel table generation means 5 performs weighting on an interference channel extracted on the interference channel table, based on closeness of wavelength to the failure occurrence channel, and generates an influence channel table in which a weight is given to the interference channel.

The cause channel estimation means 6 estimates, based on the influence channel table, a channel with a large weight to be a channel having a possibility of exerting a negative influence on the failure occurrence channel.

With the above configuration, the network monitoring device according to the present example embodiment can estimate, at low cost and quickly, a channel having a possibility of being a cause of a failure.

### Second Example Embodiment

In the present example embodiment, a specific form of a network monitoring device is described, but before this, a general configuration of a disaggregation type communication system is described.

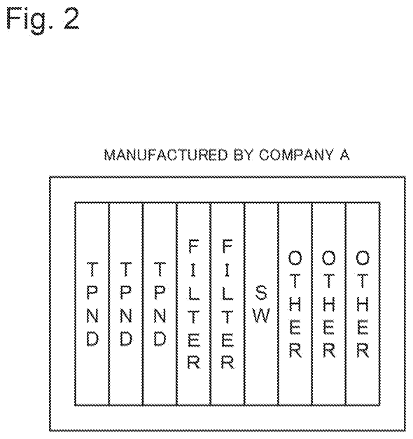

FIG. 2 is a conceptual diagram illustrating one example of a configuration of an all-in-one type communication system. In the all-in-one type communication system, one communication system vendor supplies each piece of equipment of a component. Thus, a communication network constituted of a plurality of nodes is designed in such a way that a communication quality is ensured. In the example of FIG. 2, the system includes a transponder (TPND), a filter, a switch (SW), and others (OTHER), and these components are all manufactured by Company A.

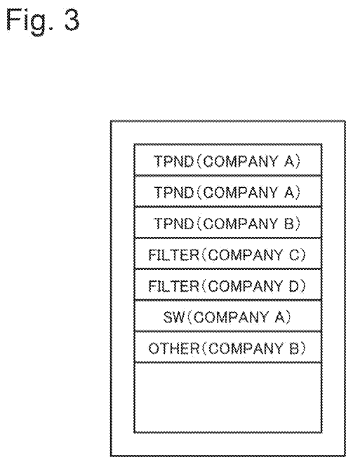

FIG. 3 is a conceptual diagram illustrating one example of a configuration of a disaggregation type communication system. As illustrated in FIG. 3, in the disaggregation type communication system, each piece of equipment constituting the system is supplied from a plurality of vendors, and products of a plurality of vendors are mixed in the system. In the example of FIG. 3, for example, TPNDs manufactured by Company A and Company B are mixed, and filters manufactured by Company C and Company D are mixed.

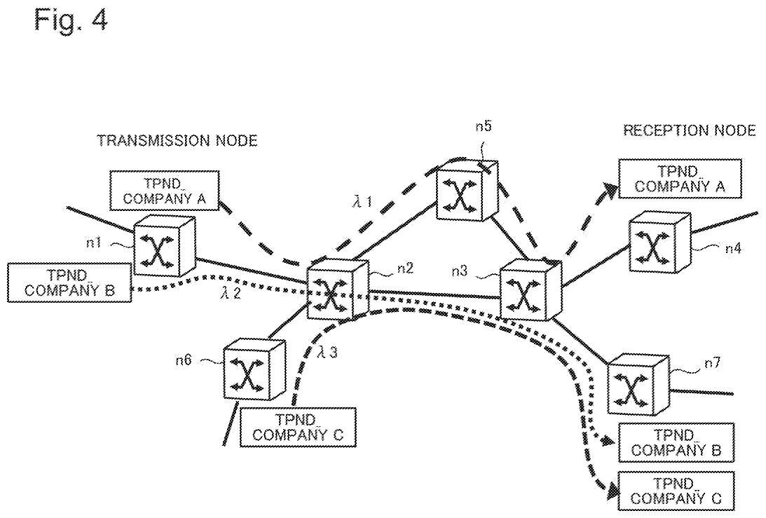

FIG. 4 is a schematic diagram of a transmission status in a multivendor equipment mixed environment. Nodes n1 to n7 are connected by a link. A signal of a channel λ1 is transmitted from the TPND manufactured by Company A at the node n1, and received by the TPND manufactured by Company A at the node n4 through the nodes n2, n5, and n3. A signal of a channel λ2 is transmitted from the TPND manufactured by Company B at the node n1, and received by the TPND manufactured by Company B at the node n7 through the nodes n2 and n3. A signal of a channel λ3 is transmitted from the TPND manufactured by Company C at the node n6, and received by the TPND manufactured by Company C at the node n7 through the nodes n2 and n3.

In the example of FIG. 4, λ1 and λ2 overlap at a link of the nodes n1-n2, and λ2 and λ3 overlap at a link of the nodes n2-n3-n7. λ1, λ2, and λ3 are relayed at the nodes n2 and n3.

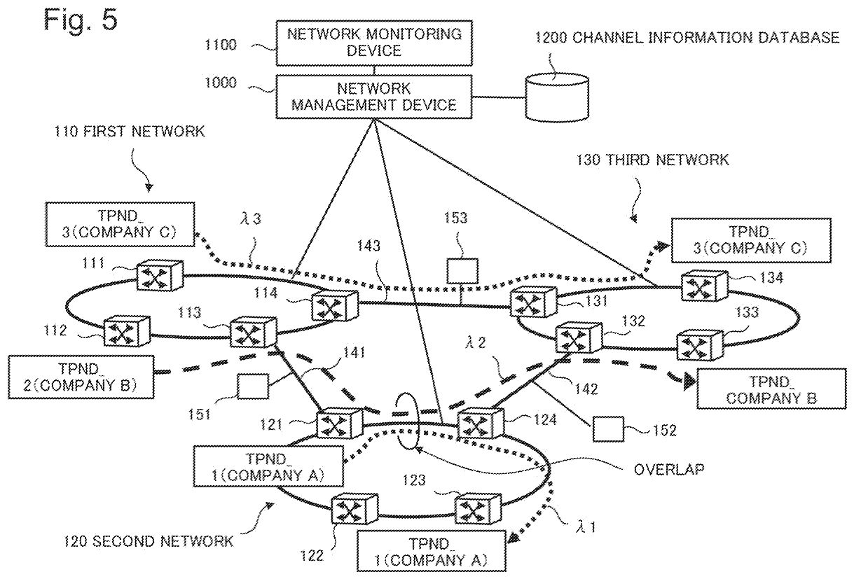

Next, a specific example of network monitoring using the network monitoring device according to the present example embodiment is described. FIG. 5 is a schematic diagram illustrating one example of a disaggregation type communication network using the network monitoring device according to the second example embodiment. This network includes a first network 110, a second network 120, and a third network 130 that are ring-shaped. Nodes 111 to 114 are connected in a ring shape in the first network 110, nodes 121 to 124 are connected in a ring shape in the second network 120, and nodes 131 to 134 are connected in a ring shape in the third network 130. Each ring-shaped network is connected by connection links 141, 142, and 143. Each node is controlled by a network management device 1000 (network management system, NMS). A network monitoring device 1100 functions as a part of the network management device 1000, and monitors a state of a network. A channel information database 1200 that retains information about a channel existing in a network is connected to the network management device 1000. The channel information database 1200 retains, as channel information, a wavelength of light used by each channel, a route (a network number, a node, and a link), a TPND number, and the like. Although a case where the network is ring-shaped is illustrated as an example in FIG. 5, a shape of a network may be another shape such as a meshed shape or a linear shape. The network monitoring device 1100 can be implemented on, for example, a computer equipped with a processor, a memory, a storage device, and an input/output device.

In the example of FIG. 5, spectrum analyzers 151, 152, and 153 are disposed in the connection links 141, 142, and 143, respectively. Since a band of a channel to be a target is in a range of an adjacent channel, the spectrum analyzers can be, for example, spectrum analyzers being narrow-band-tunable and being tunably sweepable. When a network is in another form having a meshed shape or the like, a spectrum analyzer is preferably disposed selectively in a place where network traffic particularly concentrates.

The number of TPNDs being relevant to the number of channels to be multiplexed by WDM is disposed in each node. FIG. 5 illustrates, as an example, a case where a TPND_1 manufactured by Company A, a TPND_2 manufactured by Company B, and a TPND_3 manufactured by Company C are used for some of the TPNDs.

As one example of communication, a case is described where a signal of λ1 is transmitted from the TPND_1 of the node 121 to the TPND_1 of the node 123, and a signal of λ2 is transmitted from the TPND_2 of the node 112 to the TPND_2 of the node 133. It is assumed that a signal of λ3 is transmitted from the TPND_3 of the node 111 to the TPND_3 of the node 134.

Herein, when routes of the channels of λ1 and λ2 are compared, it is understood that the routes overlap in a link between the nodes 121 and 124. With an abnormality in one of the channels when there is such an overlap, a negative influence may be exerted on another channel, and a failure may occur. The network monitoring device 1100 according to the present example embodiment is intended to quickly specify a TPND being a cause of a failure in such a case. The following description assumes that a signal of λ1 receives a negative influence from λ2 having an abnormality and another signal, and a failure occurs.

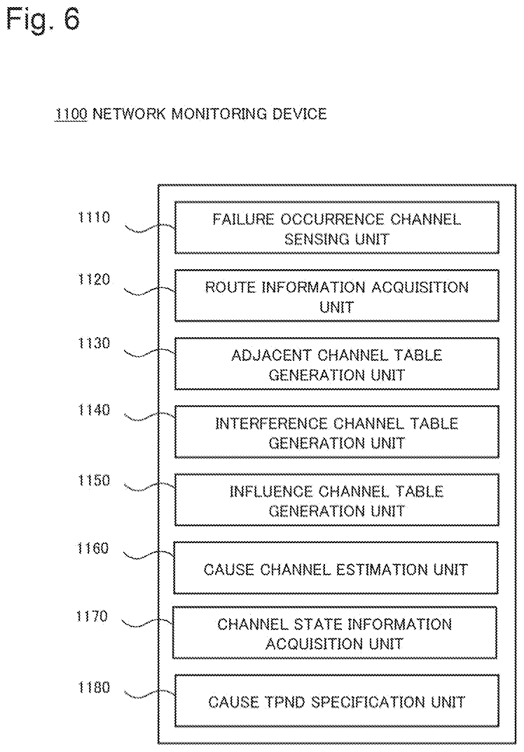

FIG. 6 is a block diagram illustrating the network monitoring device 1100 according to the present example embodiment. The network monitoring device 1100 includes a failure occurrence channel sensing unit 1110, a route information acquisition unit 1120, an adjacent channel table generation unit 1130, an interference channel table generation unit 1140, and an influence channel table generation unit 1150. The network monitoring device 1100 also includes a cause channel estimation unit 1160, a channel state information acquisition unit 1170, and a cause TPND specification unit 1180.

The failure occurrence channel sensing unit 1110 senses a channel in which a failure occurs in a network. Sensing of a failure can be performed by a method being compliant with, for example, PTL 1 (Japanese Unexamined Patent Application Publication (Translation of PCT Application) No. 2014-523149). In other words, the failure occurrence channel sensing unit 1110 acquires a quality parameter of communication from a transponder disposed in each node, and detects, based on the received quality parameter, a path having deteriorated communication quality, as a first deteriorated path. The failure occurrence channel sensing unit 1110 specifies an associated path having an association with the first deteriorated path. Further, the failure occurrence channel sensing unit 1110 detects a path having deteriorated communication quality among associated paths, as a second deteriorated path. Thereafter, the failure occurrence channel sensing unit 1110 can perform sensing of a failure occurrence channel by specifying, to be a fault node or a fault link, a node or a link where both the first deteriorated path and the second deteriorated path pass.

The route information acquisition unit 1120 acquires route information about a channel in which a failure occurs. The route information can be acquired from the network management device 1000.

The adjacent channel table generation unit 1130 extracts an adjacent channel being close in wavelength to the failure occurrence channel, and generates an adjacent channel table including route information of the adjacent channel. Adjacent channels can be, for example, about five channels having adjacent wavelengths.

The interference channel table generation unit 1140 extracts, as an interference channel, a channel sharing a common route (overlap) with a failure occurrence channel among the adjacent channels, and generates an interference channel table.

The influence channel table generation unit 1150 performs weighting on an interference channel extracted on the interference channel table, based on closeness of wavelength to the failure occurrence channel, and generates an influence channel table in which a weight is given to the interference channel.

The cause channel estimation unit 1160 specifies, based on a degree of a weight written in the influence channel table, a channel having a possibility of exerting a negative influence on the failure occurrence channel, to be a cause channel.

The channel state information acquisition unit 1170 acquires state information of a channel (cause channel) having a possibility of exerting a negative influence on another channel. State information of a channel is, for example, a spectrum of the channel, and is acquired from a spectrum analyzer disposed in each connection link.

The cause TPND specification unit 1180 specifies a TPND being a cause of a negative influence, based on channel state information acquired in regard to a cause channel suspected of being a cause of the negative influence.

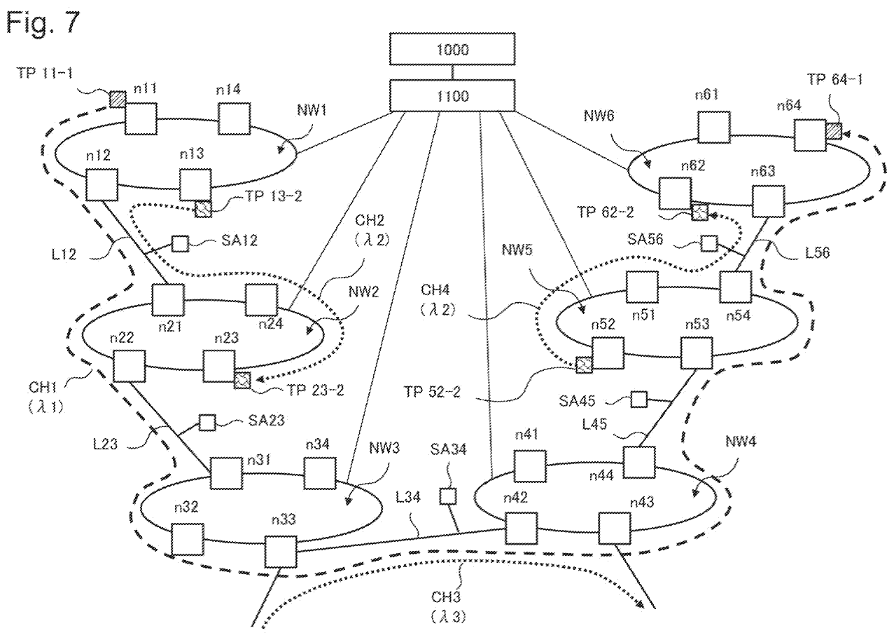

Next, the network monitoring device 1100 is described by use of a more specific example. FIG. 7 is a schematic diagram illustrating a network, the network management device 1000 that manages the network, and a network management system including the network monitoring device 1100. In this example, six ring networks NW1 to NW6 exist, and each include four nodes. It is assumed that each node has a disaggregation type configuration, i.e., a configuration in which transponders and other pieces of equipment of a plurality of vendors are mixed. A name of a node is determined in such a way that a first node of the NW1 is n11, a second node is n12, a first node of the NW2 is n21, and a second node is n22.

Each ring network is connected by a connection link. Herein, it is assumed that a connection link connecting the NW1 and the NW2 is referred to as L12, a connection link connecting the NW2 and the NW3 is referred to as L23, . . . . Spectrum analyzers SA12, SA23, . . . are disposed in the connection links L12, L23, . . . , respectively.

The network management device 1000 acquires, in regard to the network described above, a parameter relating to a communication of each node, and information relating to a channel formed on the network and a wavelength, route, and the like of each channel, and controls a communication in the network.

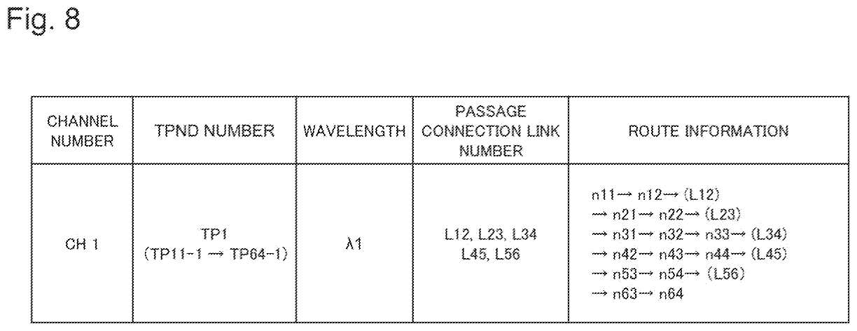

Next, a table used in the network monitoring device 1100 is described. FIG. 8 is a table illustrating one example of a route information table representing route information. In this example, a channel number, a TPND number, a wavelength, a passage connection link, and route information regarding a CH1 are described. The channel number is an ID of a channel. The TPND number represents a kind (model number) of a TPND used for transmission and reception. The wavelength is a wavelength of light used by the channel. A passage connection link number is a number of a connection link in which a channel passes. In the example of FIG. 7, the connection link is a link connecting adjacent ring networks. The route information describes a node of the channel that is passed from transmission to reception.

In the present example embodiment, it is assumed that a failure occurs in the CH1. It is assumed that an adjacent channel is a channel using a wavelength close to the wavelength λ1 used by the CH1. It is assumed that an order of closeness of wavelength to λ1 is λ2, λ3, λ4, . . . .

When sensing that a failure occurs in the CH1, the network monitoring device 1100 extracts, as an adjacent channel, a channel using a wavelength close to λ1, and generates an adjacent channel table. It is assumed that differing channels may use the same wavelength unless routes overlap. In other words, a plurality of channels using λ2 and λ3 may exist.

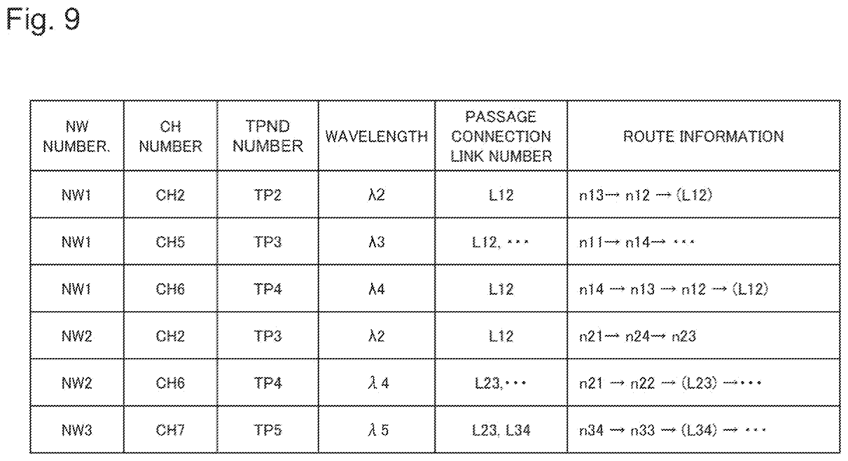

FIG. 9 is a table illustrating one example of an adjacent channel table. In the example of FIG. 9, an adjacent channel of the CH1 using the wavelengths λ2 to λ5 close to λ1 is extracted, and a network (NW) number, a channel (CH) number, a TPND number, a passage connection link number, and route information of the adjacent channel are described. As already described, there may be a plurality of channels using the same wavelength unless routes overlap. The adjacent channel table is generated with the NW number as a key. This is related to later-described specification of a TPND exerting a negative influence on a failure.

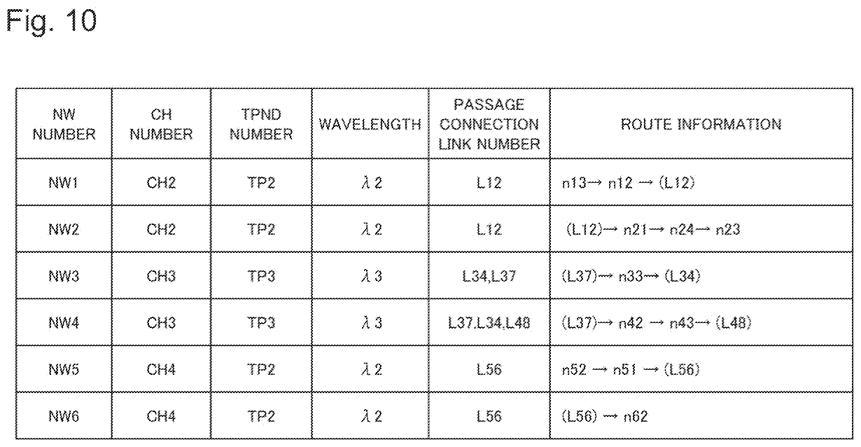

The network monitoring device 1100 extracts, from the generated adjacent channel table, a channel sharing a common route (having an overlap) with the CH1 in which a failure occurs, and generates an interference channel table that retains information about the channel. FIG. 10 is a table illustrating one example of an interference channel table. In the example of FIG. 10, the interference channel table describes an NW number, a channel (CH) number, a TPND number, a wavelength, a passage connection link number, and route information. For example, it is assumed that, in the NW1, the CH2 shares the L12 with the CH1 as a common route. It is assumed that, in the NW4, the CH3 shares the L34, the n42, and the n43 with the CH1 as a common route. As already described, differing channels may use light at the same wavelength unless routes overlap. Thus, in the interference channel table of FIG. 10, a plurality of the channels CH2 and CH4 using λ2 are extracted.

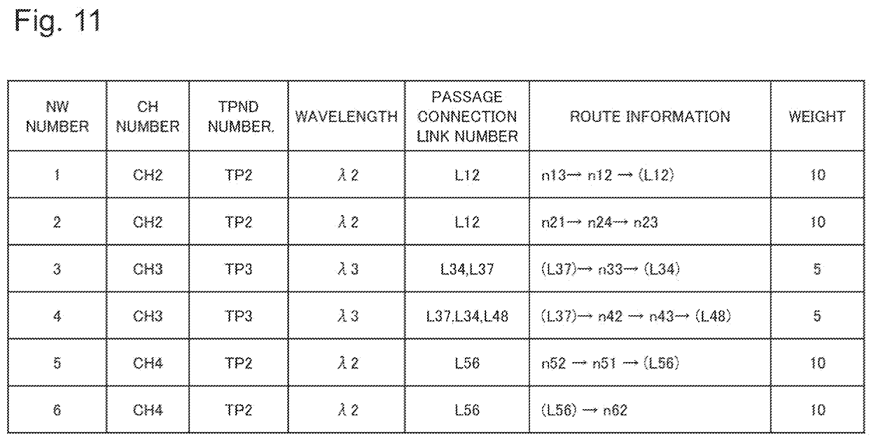

FIG. 11 is a table illustrating one example of an influence channel table. In the influence channel table, a weight is given to an interference channel extracted on the interference channel table, based on closeness to a wavelength of a failure occurrence channel. A weight indicates strength of an influence on a failure occurrence channel, and has a larger value as a wavelength is closer. In the example of FIG. 11, it is assumed that a weight of a channel 2 of λ2 being a wavelength closest to the wavelength λ1 of a failure occurrence channel is 10, and a weight of λ3 being the next closest wavelength is 5. However, a method of weighting is not limited to this, and can be any value with which strength of an influence can be appropriately evaluated. A channel having a high possibility of exerting a negative influence on the CH1 is extracted by the influence channel table. From the example of FIG. 11, it is understood that the CH2 and the CH4 are first candidates, and a next is the CH3.

As described with FIG. 7, in the network management system according to the present example embodiment, a spectrum analyzer is disposed in each connection link. The network monitoring device 1100 acquires, from a spectrum analyzer disposed in a connection link where a channel extracted on the influence channel table passes, a spectrum of a signal in the connection link. In the example of FIG. 10, first, a spectrum of the connection link L12 where the CH2 being the first candidate passes is acquired. The network monitoring device 1100 compares, with a predetermined threshold value, data such as a wavelength, a band width, power, and the like relating to a spectrum, and determines whether the spectrum (λ2) of the CH2 has an abnormality such as thickening or thinning of a band, largeness or smallness of power, or a deviance of a wavelength. Herein, when an abnormality is found in the spectrum of the CH2, the network monitoring device 1100 can specify a channel exerting a negative influence on the CH1 to be the CH2. The network monitoring device 1100 can specify a TPND being a cause of the abnormality to be either a TP13-2 disposed in the n13 or a TP23-2 disposed in the n23. Although determination of whether the CH2 has an abnormality is performed first in the above description, determination of the CH4 that is also the first candidate may be performed first.

When determinations of the CH2 and the CH4 are performed and each of the CH2 and the CH4 has no abnormality, presence or absence of an abnormality is determined in regard to the CH3 being the next candidate, by a similar operation. When there is an abnormality, a TPND being a cause of the abnormality can be specified by an operation similar to that in the above description.

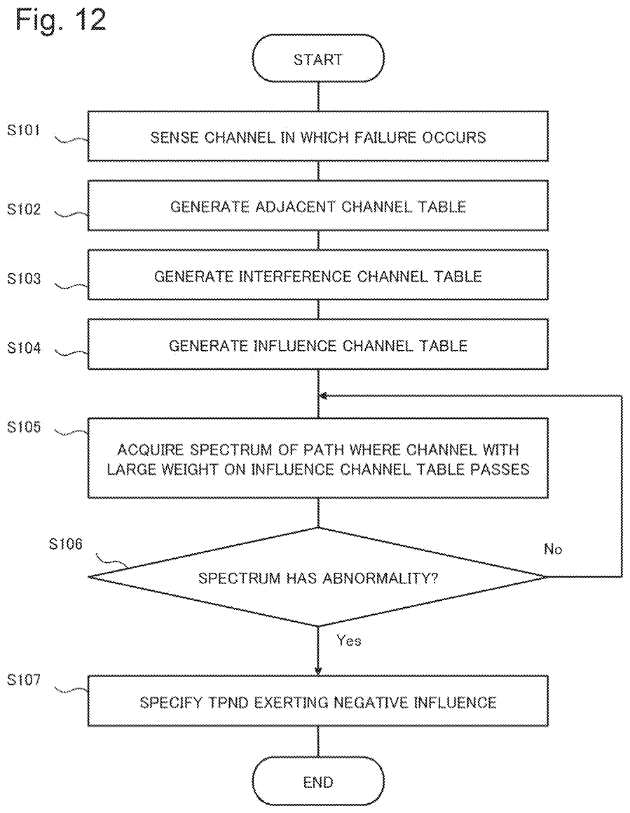

FIG. 12 is a flowchart illustrating an operation of the network monitoring device described above. First, a channel in which a failure occurs is sensed (S101). Next, a channel using a wavelength being adjacent to a wavelength of a failure occurrence channel is extracted, and an adjacent channel table is generated (S102). Next, among the adjacent channels extracted on the adjacent channel table, a channel sharing a common route with the failure occurrence channel is extracted as an interference channel, and an interference channel table is generated (S103). Next, in regard to the interference channel extracted on the interference channel table, weighting based on closeness of wavelength to the failure occurrence channel is performed, and an influence channel table is generated (S104). Next, in regard to a channel with a large weight on the influence channel table, a spectrum is acquired (S105), and whether the spectrum has an abnormality is determined (S106). Herein, when the spectrum has an abnormality (S106_Yes), a TPND that transmits and receives in the channel is specified to be an abnormal TPND (S107). On the other hand, when the spectrum has no abnormality (S106_No), the operation returns to S105, and presence or absence of an abnormality of a spectrum is determined in regard to a channel to be a next candidate.

A channel having a possibility of exerting a negative influence on a failure channel can be quickly ascertained from among a large number of channels by using the adjacent channel table, the interference channel table, and the influence channel table described above. Since acquisition of a spectrum may be performed on an ascertained route, the number of spectrum analyzers to be disposed can be decreased. In the example according to the present example embodiment, a spectrum analyzer is disposed in each connection link alone. Since a band of a wavelength from which a spectrum is acquired may be a band being close to a wavelength of a failure occurrence channel, utilization of an inexpensive spectrum analyzer is possible. Since a spectrum is inspected by ascertaining a channel having a possibility of exerting a negative influence, a probability that a TPND being a cause of an abnormality can be quickly specified can be heightened.

### Third Example Embodiment

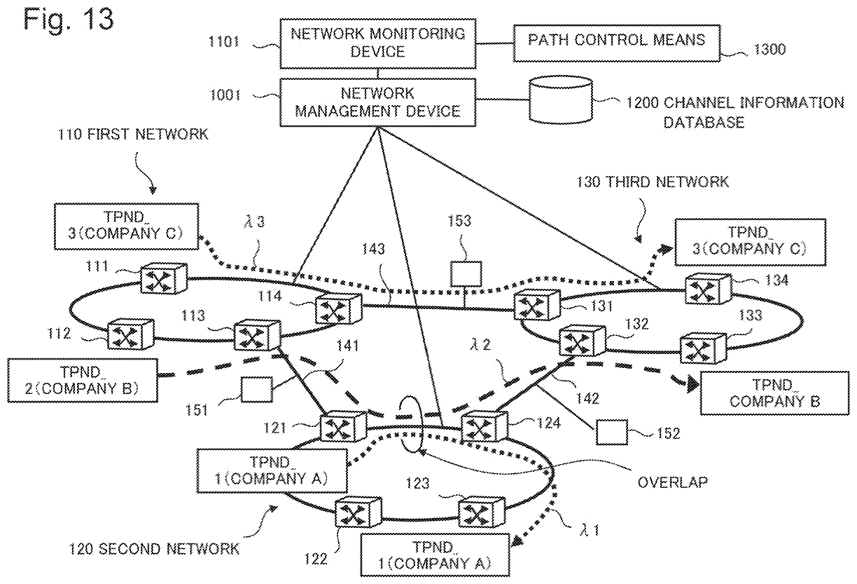

FIG. 13 is a schematic diagram illustrating one example of a disaggregation type communication network using a network monitoring device 1101 according to the present example embodiment. In this configuration, a path control means 1300 is connected to the network monitoring device 1101, in addition to the network according to the second example embodiment. The path control means 1300 deletes or changes, to a route/wavelength having no influence, a communication route of a transponder that is specified to exert a negative influence on another channel.

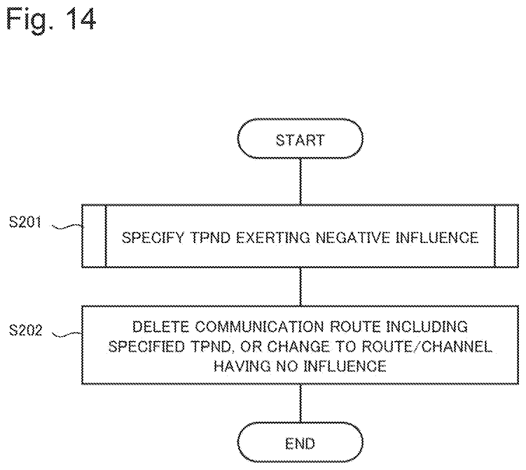

Next, an operation of the network monitoring device 1101 is described. FIG. 14 is a flowchart illustrating an operation of the network monitoring device 1101.

First, a TPND exerting a negative influence on a failure occurrence channel is specified (S201). Since this operation is the same as that according to the second example embodiment in FIG. 12, S201 is described as defined processing including S101 to S107 in FIG. 12. Next, the path control means 1300 deletes or changes, to a route/channel having no influence, a communication route including the specified TPND (S202).

A TPND exerting a negative influence on another channel can be switched to another TPND by the configuration and operation as above. Thus, a stable communication environment can be provided.

### Fourth Example Embodiment

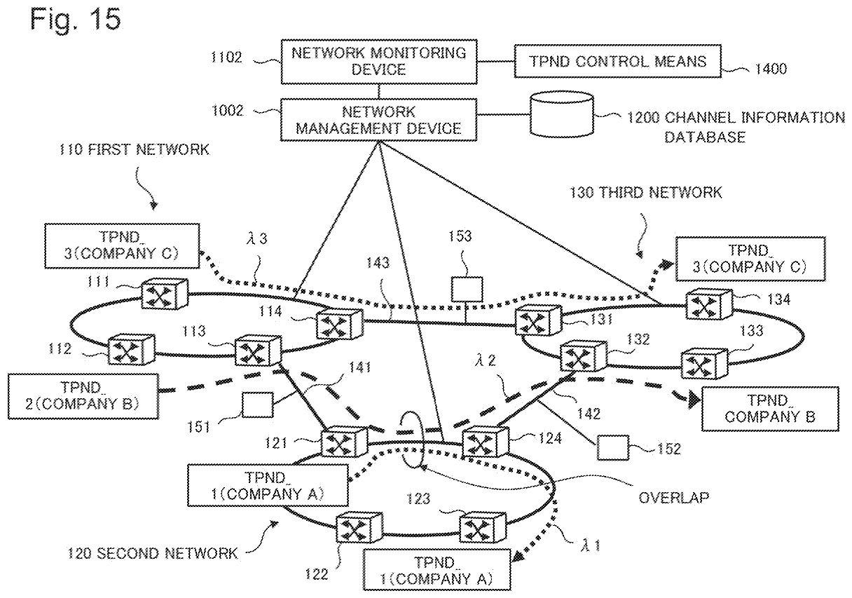

FIG. 15 is a schematic diagram illustrating one example of a disaggregation type communication network using a network monitoring device 1102 according to the present example embodiment. The network monitoring device 1102 includes a TPND control means 1400, in addition to the configuration of the network monitoring device 1100 according to the second example embodiment. The TPND control means 1400 adjusts a parameter (optical power or the like) of a transponder that is specified to exert a negative influence on another channel, in such a way as to have no influence on the another channel.

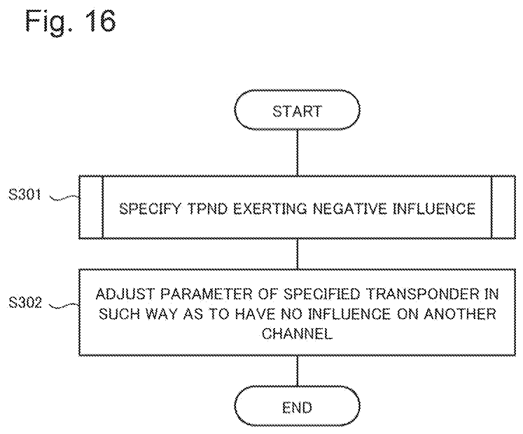

Next, an operation of the network monitoring device 1102 is described. FIG. 16 is a flowchart illustrating an operation of the network monitoring device 1102.

First, a TPND exerting a negative influence on a failure occurrence channel is specified (S301). Since this operation is the same as that according to the second example embodiment in FIG. 12, S301 is described as defined processing including S101 to S107 in FIG. 12. Next, the TPND control means 1400 adjusts a parameter (optical power or the like) of the specified TPND in such a way as to have no influence on another channel (S302).

A TPND exerting a negative influence on another channel can be adjusted by the configuration and operation as above in such a way that no influence is exerted on the another channel. Thus, a stable communication environment can be provided.

### Fifth Example Embodiment

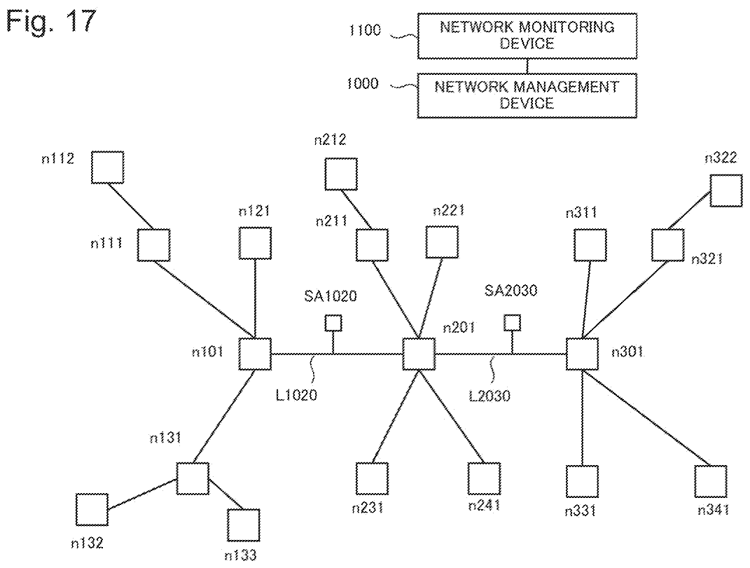

Although the first to fourth example embodiments are described by use of a multi-ring network in which a ring-shaped network is connected by a connection link, the first to fourth example embodiments can be similarly applied to a network with another topology as well. FIG. 17 is a schematic diagram illustrating one example of a disaggregation type communication network in which the network monitoring device 1100 according to the second example embodiment is applied to an extended-star type network. This network is constituted of nodes n101, n111, n112, n121, . . . , n201, . . . , n301, TPNDs of a plurality of vendors are mixedly disposed in each node. Although illustration is omitted in the drawing, it is assumed that the network management device 1000, the network monitoring device 1100, and each node are connected.

In the example of FIG. 17, spectrum analyzers are disposed in links L1020 and L2030 where network traffic concentrates. In this way, an advantageous effect similar to that according to each of the first to fourth example embodiments can be achieved in a network having a topology other than multi-ring, by providing a configuration that acquires state information (spectrum) of a channel from a link where network traffic concentrates. In other words, a TPND exerting a negative influence on a failure occurrence channel can be quickly specified.

A program that causes a computer to execute the processing according to the first to fifth example embodiments described above, and a recording medium storing the program also fall within the scope of the present invention. For example, a magnetic disc, a magnetic tape, an optical disc, a magneto-optical disc, a semiconductor memory, or the like can be used as a recording medium.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

(Supplementary Note 1)

A network monitoring device including:

a failure occurrence channel sensing means for sensing a failure occurrence channel in which a failure occurs in a network;

a route information acquisition means for acquiring route information of the failure occurrence channel;

an adjacent channel table generation means for extracting an adjacent channel being close in wavelength to the failure occurrence channel, and generating an adjacent channel table including route information of the adjacent channel;

an interference channel table generation means for extracting, as an interference channel, a channel sharing a common route with the failure occurrence channel among the adjacent channels, and generating an interference channel table in which the interference channel and the route information are linked together;

an influence channel table generation means for giving a weight to the interference channel, based on closeness of wavelength to the failure occurrence channel, and generating an influence channel table in which the weight is given to the interference channel table; and

a cause channel estimation means for estimating, based on the influence channel table, a cause channel having a possibility of exerting a negative influence on the failure occurrence channel.

(Supplementary Note 2)

The network monitoring device according to Supplementary Note 1, further including

a channel state information acquisition means for acquiring state information of the cause channel.

(Supplementary Note 3)

The network monitoring device according to Supplementary Note 2, wherein

state information of the cause channel is acquired from a route where traffic concentrates.

(Supplementary Note 4)

The network monitoring device according to Supplementary Note 3, wherein

the route where traffic concentrates is a connection link of a multi-ring network.

(Supplementary Note 5)

The network monitoring device according to any one of Supplementary Notes 2 to 4, further including

a cause transponder specification means for specifying, based on the state information, a cause transponder being associated with the cause channel.

(Supplementary Note 6)

The network monitoring device according to Supplementary Note 5, further including

a path control means for deleting a communication route including the cause transponder, or changing the communication route to a route having no influence.

(Supplementary Note 7)

The network monitoring device according to Supplementary Note 5 or 6, further including

a transponder control means for adjusting a parameter of the cause transponder in such a way that no influence is exerted on another channel.

(Supplementary Note 8)

The network monitoring device according to any one of Supplementary Notes 2 to 7, wherein

the channel state information acquisition means is a spectrum analyzer.

(Supplementary Note 9)

The network monitoring device according to Supplementary Note 8, wherein

the spectrum analyzer is disposed on the route where traffic concentrates.

(Supplementary Note 10)

A network monitoring system including:

the network monitoring device according to any one of Supplementary Notes 1 to 9; and

a network management device that controls the network.

(Supplementary Note 11)

A network monitoring method including:

sensing a failure occurrence channel in which a failure occurs in a network;

acquiring route information of the failure occurrence channel;

extracting an adjacent channel being close in wavelength to the failure occurrence channel;

generating an adjacent channel table including route information of the adjacent channel;

extracting, as an interference channel, a channel sharing a common route with the failure occurrence channel among the adjacent channels;

generating an interference channel table in which the interference channel and the route information are linked together;

giving a weight to the interference channel, based on closeness of wavelength to the failure occurrence channel;

generating an influence channel table in which the weight is given to the interference channel table; and

estimating, based on the influence channel table, a cause channel having a possibility of exerting a negative influence on the failure occurrence channel.

(Supplementary Note 12)

The network monitoring method according to Supplementary Note 11, further including

acquiring state information of the cause channel.

(Supplementary Note 13)

The network monitoring method according to Supplementary Note 12, further including

acquiring state information of the cause channel from a route where traffic concentrates.

(Supplementary Note 14)

The network monitoring method according to Supplementary Note 13, wherein

the route where traffic concentrates is a connection link of a multi-ring network.

(Supplementary Note 15)

The network monitoring method according to any one of Supplementary Notes 12 to 14, further including

specifying, based on the state information, a cause transponder being associated with the cause channel.

(Supplementary Note 16)

The network monitoring method according to Supplementary Note 15, further including

deleting a communication route including the cause transponder, or changing the communication route to a route having no influence.

(Supplementary Note 17)

The network monitoring method according to Supplementary Note 15 or 16, further including

adjusting a parameter of the cause transponder in such a way that no influence is exerted on another channel.

(Supplementary Note 18)

The network monitoring method according to any one of Supplementary Notes 12 to 17, further including

acquiring the state information by a spectrum analyzer.

(Supplementary Note 19)

The network monitoring method according to Supplementary Note 18, further including

disposing the spectrum analyzer on the route where traffic concentrates.

(Supplementary Note 20)

A network monitoring program causing a computer to execute processing including:

a step of sensing a failure occurrence channel in which a failure occurs in a network;

a step of acquiring route information of the failure occurrence channel;

a step of extracting an adjacent channel being close in wavelength to the failure occurrence channel;

a step of generating an adjacent channel table including route information of the adjacent channel;

a step of extracting, as an interference channel, a channel sharing a common route with the failure occurrence channel among the adjacent channels;

a step of generating an interference channel table in which the interference channel and the route information are linked together;

a step of performing weighting on the interference channel, based on closeness of wavelength to the failure occurrence channel;

a step of generating an influence channel table in which a weight is given to the interference channel table; and

a step of estimating, based on the influence channel table, a cause channel having a possibility of exerting a negative influence on the failure occurrence channel.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty.

Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A network monitoring device comprising:
a failure occurrence channel sensor sensing a channel in which a failure occurs in a network;
a route information acquirer acquiring route information of a channel in which a failure occurs;
an adjacent channel table generator extracting an adjacent channel being close in wavelength to a failure occurrence channel, and generating an adjacent channel table including route information of an adjacent channel;
an interference channel table generator extracting a channel sharing a common route with a failure occurrence channel among adjacent channels as an interference channel, and generating an interference channel table;
an influence channel table generator giving a weight to the interference channel, based on closeness of wavelength to a failure occurrence channel, and generating an influence channel table in which the weight is given to the interference channel table; and
a cause channel estimator estimating a cause channel having a possibility of exerting a negative influence on the failure occurrence channel based on the influence channel table.

2. The network monitoring device according to claim 1, further comprising
a channel state information acquirer acquiring a state information of the cause channel.

3. The network monitoring device according to claim 2, wherein
the state information of the cause channel is acquired from a route where traffic concentrates.

4. The network monitoring device according to claim 3, wherein
the route where traffic concentrates is a connection link of a multi-ring network.

5. The network monitoring device according to claim 3, further comprising
a cause transponder specifying unit specifying a cause transponder being associated with the cause channel based on the state information.

6. The network monitoring device according to claim 5, further comprising
a path controller deleting a communication route including the cause transponder, or changing the communication route to a route having no influence.

7. The network monitoring device according to claim 2, wherein
the channel state information acquirer is a spectrum analyzer.

8. A network monitoring system comprising:
the network monitoring device according to claim 1; and
a network management device that controls the network.

9. A network monitoring method comprising:
sensing a failure occurrence channel in which a failure occurs in a network;
acquiring route information of the failure occurrence channel;
extracting an adjacent channel being close in wavelength to the failure occurrence channel;
generating an adjacent channel table including route information of the adjacent channel;
extracting a channel sharing a common route with the failure occurrence channel among the adjacent channels as an interference channel;
generating an interference channel table in which the interference channel and the route information are linked together;
giving a weight to the interference channel, based on closeness of wavelength to the failure occurrence channel;
generating an influence channel table in which a weight is given to the interference channel table; and
estimating a cause channel having a possibility of exerting a negative influence on the failure occurrence channel based on the influence channel table.

10. A program storage medium that stores in itself a network monitoring program causing a computer to execute processing including:
a step of sensing a failure occurrence channel in which a failure occurs in a network;
a step of acquiring route information of the failure occurrence channel;
a step of extracting an adjacent channel being close in wavelength to the failure occurrence channel;
a step of generating an adjacent channel table including route information of the adjacent channel;
a step of extracting, as an interference channel, a channel sharing a common route with the failure occurrence channel among the adjacent channels;
a step of generating an interference channel table in which the interference channel and the route information are linked together;
a step of giving a weight to the interference channel, based on closeness of wavelength to the failure occurrence channel;
a step of generating an influence channel table in which a weight is given to the interference channel table; and
a step of estimating, based on the influence channel table, a cause channel having a possibility of exerting a negative influence on the failure occurrence channel.

11. The network monitoring device according to claim 4, further comprising
a cause transponder specifying unit specifying a cause transponder being associated with the cause channel based on the state information.

12. The network monitoring device according to claim 3, wherein
the channel state information acquirer is a spectrum analyzer.

13. The network monitoring device according to claim 4, wherein
the channel state information acquirer is a spectrum analyzer.

14. The network monitoring device according to claim 5, wherein
the channel state information acquirer is a spectrum analyzer.

15. The network monitoring device according to claim 6, wherein
the channel state information acquirer is a spectrum analyzer.

16. A network monitoring system comprising:
the network monitoring device according to claim 2; and
a network management device that controls the network.

17. A network monitoring system comprising:
the network monitoring device according to claim 3; and
a network management device that controls the network.

18. A network monitoring system comprising:
the network monitoring device according to claim 4; and
a network management device that controls the network.

19. A network monitoring system comprising:
the network monitoring device according to claim 5; and
a network management device that controls the network.

20. A network monitoring system comprising:
the network monitoring device according to claim 6; and
a network management device that controls the network.
